(19) United States
(12) Patent Application Publication
(10) Pub. No.: US 2007/0124571 A1
(43) Pub. Date: May 31, 2007

(54) System and method for information handling system jack retasking

(76) Inventors: Joshua N. Alperin, Austin, TX (US); Douglas Peeler, Austin, TX (US)

Correspondence Address: HAMILTON & TERRILE, LLP, P.O. BOX 203518, AUSTIN, TX, 78720, US

(21) Appl. No.: 11/289,987

(22) Filed: Nov. 30, 2005

(51) Int. Cl. G06F 15/177; G06F 9/24; G06F 9/00

(52) U.S. Cl. 713/1

(57) ABSTRACT

Information handling system audio jack tasks are selectively set by an end user through an audio driver jack retasker that associates each of plural audio jacks with one of plural tasks in a jack task table. For example, a WINDOWS operating system having a UAA class driver supports jack retasking by providing end user access to UAA jack task tables stored in system BIOS. Audio jacks are selectively retasked between audio tasks, such as microphone signal in or headphone speaker out, and other tasks, such as line in or line out functions.

### BACKGROUND OF THE INVENTION

1. Field of the Invention

The present invention relates in general to the field of information handling system cable connections, and more particularly to a system and method for error messaging of an incorrect information handling system graphics cable connection to a projector.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems have gradually transformed from having a primary use as business tools into high-tech entertainment platforms. Users often play audio and video files from digital storage media, such as Compact Discs (CDs) and Digital Versatile Discs (DVDs). Information handling systems have, indeed, transformed the entertainment industry by providing digital recording and editing capabilities. For instance, consumers now commonly create their own DVDs with digital cameras and information handling systems that burn digital images to DVDs. As a result, consumers desire increased flexibility in the formats and media that information handling systems use. Industry has responded by including an increasing number of audio visual formats to record and present information. One example is the High Definition Audio (HDA), which defines standardized formats for digital audio information. Another example is the Universal Audio Architecture (UAA), which describes a class driver architecture for information handling system audio solutions. Compliance with UAA by an audio chipset provides driver support to operate the chipset within the WINDOWS operating system, thus reducing or eliminating the need for loading manufacturer specific drivers on an information handling system to have audio functionality.

Some difficulties that arises with the integration of greater audiovisual capability in information handling systems include the greater cost of the various hardware devices involved, such as devices that support peripheral speakers and microphones, as well as the greater footprint and power consumption associated with such devices. In U.S. patent application Ser. No. 11/117,277, filed Apr. 28, 2005, entitled “System and Method for Sensing Information Handling System Jack Activity,” by Joshua Alperin and Douglas Peeler and assigned to Dell Products LP, a CODEC of the information handling system is diverted from a primary purpose to sense jack activity at a HDA resistor tree. Diverting the CODEC from a primary purpose to detect jack activity supports jack retasking without adding an additional analog to digital converter CODEC to the information handling system. Jack retasking with HDA reduces the total number of jacks needed for an information handling system by allowing a jack to perform multiple tasks, such as supporting both a microphone input and a speaker output or even providing a line out or other function. UAA does not support jack retasking so that extra jacks are needed to provide the same flexibility as HDA systems that allow jack retasking.

### SUMMARY OF THE INVENTION

Therefore a need has arisen for a system and method which supports jack retasking in a UAA or similar environment.

In accordance with the present invention, a system and method are provided which substantially reduce the disadvantages and problems associated with previous methods and systems for assigning tasks to jacks of an information handling system. Audio jack tasks of an information handling system are selectively configured by an end user and stored for application by an audio device driver so that the end user selectively configures each of plural jacks to perform a selected of plural functions.

More specifically, an information handling system chipset supports population of a UAA class driver with configuration settings stored in firmware, such as a jack task table in the BIOS. An audio driver jack retasker provides end user access to the jack task table through a display interface to allow the end user to selectively associate each jack with a desired of plural tasks. For instance, the jack retasker provides access to the jack task table in a BIOS setup mode so that the BIOS boots the information handling system by applying end user jack function settings to a UAA class driver. As an example, the end user may set a jack output task in a jack retasker interface so that the jack will provide an audio out to a headphone speaker or a line out. As another example, the end user may set a jack input task in a jack retasker interface so that the jack will provide an audio in from a microphone or a line in. The jack function is determined by the UAA class driver from UAA setup tables to which the end user has access for defining the jack function. When the operating system loads the UAA class driver, that driver downloads the proper operating mode from the BIOS tables and configures the audio hardware appropriately.

The present invention provides a number of important technical advantages. One example of an important technical advantage is that information handling system jacks are retasked in a UAA or similar environment. A user selects the functionality of a jack through a firmware interface for convenient and flexible assignment of a desired audio or other function to the jack. Retasking of jack functionality is provided with minimal additional cost since the hardware functionality is defined by instructions stored in firmware. Users enjoy increased flexibility for an information handling system with the option of assigning jack functionality in a manner that is most convenient to the user and the ability to alter the functionality as desired for various uses of the information handling system.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system having audio jack retasking;

FIG. 2 depicts an example of a jack retasker interface;

FIG. 3 depicts a block diagram of audio jack retasking supported through BIOS setup tables; and

FIG. 4 depicts a flow diagram of a process for audio jack retasking.

### DETAILED DESCRIPTION

Flexible task assignments for an information handling system's audio jacks are provided through BIOS setup tables that define jack tasks for a UAA class driver according to a desired user configuration. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

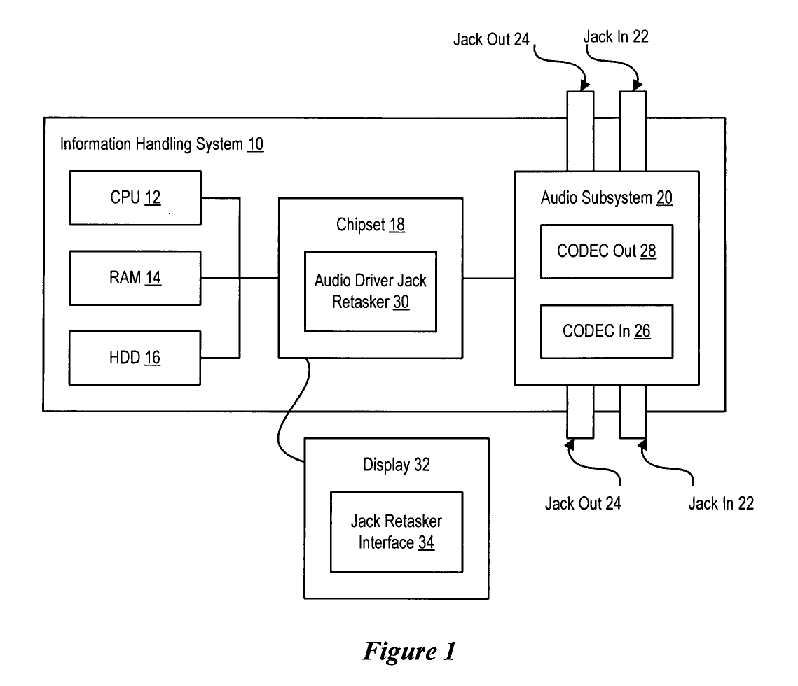

Referring now to FIG. 1, a block diagram depicts an information handling system 10 having audio jack retasking. Information handling system 10 processes information with plural processing components, such as a CPU 12, RAM 14, a hard disk drive 16, chipset 18 and audio subsystem 20. For example, CPU 12 runs applications that generate or apply audio information in cooperation with audio subsystem 20. Audio subsystem 20 receives audio information from external devices, such as a microphone, through a jack-in 22, and sends audio information to external devices, such as speakers in a headset, through a jack-out 24. Plural jacks in various locations of information handling system 10 provide convenience for an end user to connect an external cable in a desired location, such as the front or back of information handling system 10. Audio information provided from an external cable through a jack-in 22 is converted from analog to digital information by a CODEC-in 26 so that the information is usable by other processing components, such as through an I/O hub of chipset 18. Audio information provided from processing components in digital form for communication to an external cable at jack-out 24 are converted to audio signals by a CODEC-out 28.

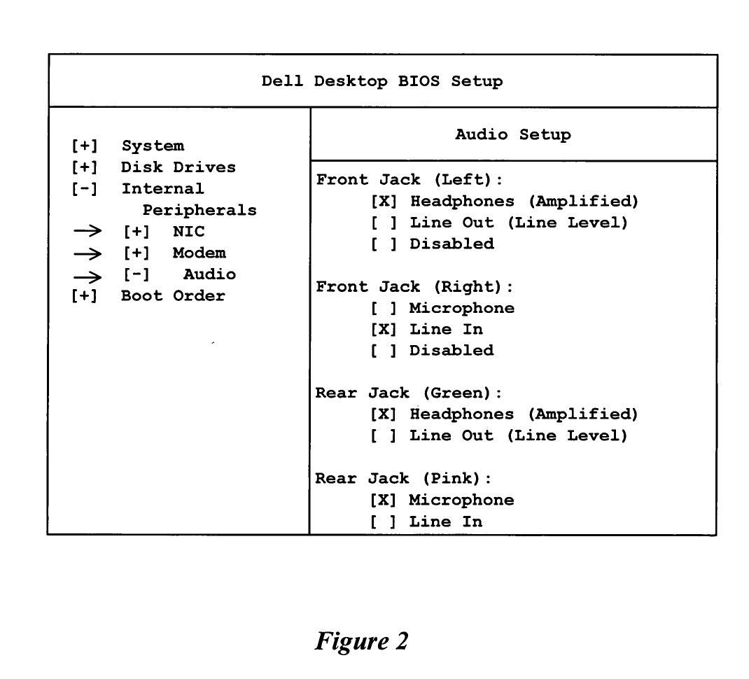

The operation of the CODECs is managed by firmware in chipset 18 and applications running on CPU 12, such as through an operating system driver. In order to provide end user control over the operation of audio subsystem 20,jacks-in 22 and jacks-out 24, an audio driver jack retasker assigns tasks to the jacks according to end user settings. For instance, audio driver jack retasker 30 interfaces with a display 32 to present a jack retasker interface 34 that accepts user inputs to define jack tasks. Chipset 18 includes firmware instructions that perform a start-up routine on application of power to information handling system 10. During the start-up routine, chipset 18 provides user jack task settings to an audio driver of the operating system running on CPU 12, such as a UAA class driver, so that the audio driver applies the jack task settings to define the functions performed by each of jacks-in 22 and jacks-out 24. FIG. 2 depicts one example of a jack retasker interface 34 presented during an end user BIOS setup request. The end user defines the function of each of the plural jacks 22 and 24 by placing an X next to the desired function. For instance, the front jack-in 22 may be set to receive a microphone signal, to receive a line-in signal or to be disabled. The front jack-out 24 may set to send a headphone speaker signal, to send a line-out signal or to be disable.

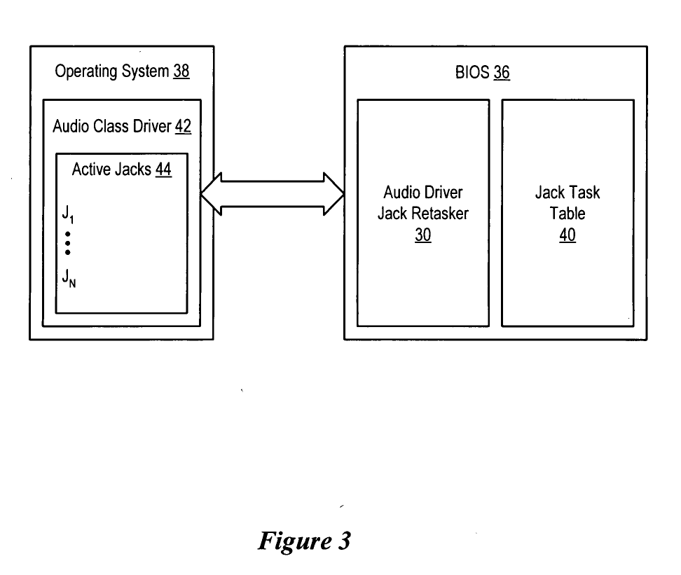

Referring now to FIG. 3, a block diagram depicts audio jack retasking supported through BIOS setup tables. Information handling system 10 coordinates operation of applications on hardware processing components with a BIOS 36 and an operating system 38. BIOS 36 has firmware instructions to bring operating system 38 into an active state, such as after power is first applied or a system restart is commanded. Audio driver jack retasker 30 stores jack tasks assigned by an end user in a jack task table, such as the tables defined by the UAA for the UAA class driver. During power-up or restart, audio class driver 42 retrieves jack task table 40 and applies the task defined in table 40 to its active jacks table 44. By allowing end user interaction with jack task table 40, audio driver jack retasker 30 supports flexible end user reconfiguration of tasks to the jacks of an information handling system while maintaining consistency with the UAA.

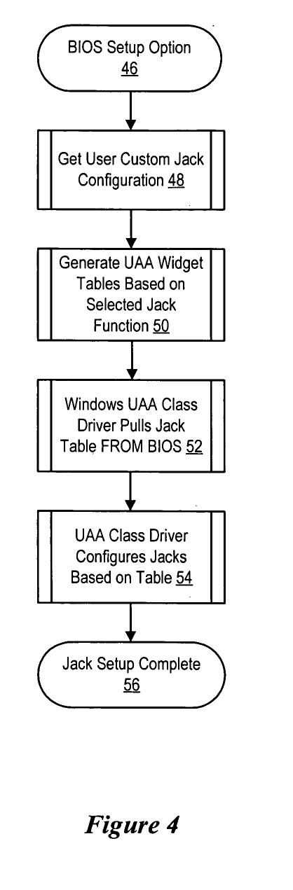

Referring now to FIG. 4, a flow diagram depicts a process for audio jack retasking. The process begins at step 46 with selection of the BIOS setup option at the information handling system to present a jack retask user interface at a display. The process continues to step 48 for input by an end user of a custom jack configuration to define one of plural functions to each of plural jacks. At step 50, the selected jack configuration is applied to generate a UAA widget table that defines each jack as having the function selected for the jack. At step 52, the WINDOWS operating system UAA class driver pulls the jack table from the BIOS, such as during a power up or restart of the information handling system. At step 54, the UAA class driver configures the jacks of the information handling system according to the settings of the table so that the jack configuration desired by the end user is applied at the information handling system.

Although the present invention has been described in detail, it should be understood that various changes, substitutions and alterations can be made hereto without departing from the spirit and scope of the invention as defined by the appended claims.

What is claimed is:

1. An information handling system comprising:
plural processing components operable to process information;
plural jacks, each jack operable to connect to an external cable for communicating information from the cable to the processing components or communicating information from the processing components to the cable;
a driver running on a processing component, the driver operable to manage a first information type or a second information type communicated across the plural jacks; and
a jack retasker operable to run on a processing component and to accept user inputs to selectively configure the driver to communicate the first information type or the second information type across one or more of the plural jacks.

2. The information handling system of claim 1 wherein the plural jacks are audio jacks and the processing components comprise an audio subsystem.

3. The information handling system of claim 2 wherein the driver comprises a UAA class driver.

4. The information handling system of claim 3 wherein the jack retasker comprises firmware instructions that define the information type for the driver at startup of the processing components.

5. The information handling system of claim 4 further comprising a jack retasker interface operable to present jack task options at a display, to accept user inputs to selectively configure the driver and to set the user inputs at the jack retasker.

6. The information handling system of claim 5 wherein the first type of information is a headphone output from the processing components to the cable and the second type of information is a line-out connector.

7. The information handling system of claim 5 wherein the first type of information is a microphone input to the processing components from the cable and the second type of information is a line-in connector.

8. A method for interfacing cables with information handling system audio jacks, the method comprising:
associating at least one of plural audio jacks with one of plural types of information in a jack task table;
storing the jack task table in firmware of the information handling system;
starting up the information handling system;
reading the jack task table from firmware with an audio driver running on the information handling system; and
configuring the driver so that each jack interfaces with the type of information associated with the jack in the jack task table.

9. The method of claim 8 wherein the plural types of information comprise microphone into a jack and line-in into the jack.

10. The method of claim 8 wherein the plural types of information comprise headphones out of a jack and line-out out of the jack.

11. The method of claim 8 wherein the audio driver comprises a UAA class driver.

12. The method of claim 8 wherein storing the jack task table in firmware further comprise storing the jack task table in a BIOS of the information handling system for access at boot of the information handling system.

13. The method of claim 12 wherein associating each of plural audio jacks further comprises:
presenting a BIOS setup interface at a display of the information handling system, the BIOS setup interface listing plural types of information available for at least one of plural audio jacks; and
selecting one of the plural types of information for association with each of the at least one of plural audio jacks.

14. The method of claim 8 further comprising:
resetting the association of at least one of the plural jacks to another of the plural types of information; and
restarting the information handling system to configure the driver to associate the reset jack with the another type of information.

15. A system for setting information handling system audio jack tasks, the system comprising:
a jack task table stored on the information handling system and defining one of plural tasks for each of plural jacks; and
an audio driver jack retasker interfaced with the jack task table and operable to apply end user inputs to alter the task for at least one of the plural jacks.

16. The system of claim 15 further comprising a jack retasker interface operable to communicate end user inputs to the audio driver jack retasker.

17. The system of claim 15 further comprising a UAA class driver operable to apply the jack task table to define jack tasks for an operating system.

18. The system of claim 15 wherein the plural tasks associated with at least one jack comprise a microphone in signal or a line in signal.

19. The system of claim 15 wherein the plural tasks associated with at least one jack comprise a speaker out signal or a line out signal.

20. The system of claim 15 wherein the plural tasks comprise a disabled jack.
